(19) United States
(12) Patent Application Publication
(10) Pub. No.: US 2006/0099862 A1
(43) Pub. Date: May 11, 2006

(54) Structure and method for connecting a braid of a shield wire

(75) Inventors: Yukihiro Yoneya, Shizuoka (JP); Takashi Ishii, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/265,257

(22) Filed: Nov. 3, 2005

(30) Foreign Application Priority Data
Nov. 5, 2004 (JP) 2004-322673

(51) Int. Cl. H01R 4/10

(52) U.S. Cl. 439/877

(57) ABSTRACT

In a structure and a method for connecting a braid of a shielding wire to a terminal in which the terminal is pressure-jointed onto the braid, the terminal is firstly jointed to the braid with a conductive adhering member to be electrically connected to the braid. The conductive adhering member includes a conductive tape and a conductive adhesive coated on both front and rear surfaces of the conductive tape. Alternatively, the conductive adhering member includes a nonconductive tape and a conductive adhesive coated on a periphery of the conductive tape. Alternatively, the conductive adhering member includes a nonconductive tape and a conductive adhesive penetrating into the nonconductive tape.

The priority application claims priority of Japanese Patent Application No. 2004-322673, which is hereby incorporated by reference.

### BACKGROUND OF THE INVENTION

1. Field of the Invention

This invention relates to a structure and a method for connecting a braid of a shielded electric wire, both of which prevent a reduction of electric contact conductivity between the braid and a terminal pressure-jointed onto the braid.

2. Description of the Related Art

Conventionally, in a case that a metallic conductive terminal is pressure-jointed onto a conductive braid of a shielded electric wire, since an inner insulating layer made of relatively soft synthetic resin is formed inside the braid, even if an outer periphery of the braid is pressure-jointed, the pressure-jointed terminal loosens with time, and electric resistance between the braid and the terminal is increased. Accordingly, there is a problem that shielding performance for shielding a core wire as a signal line of the shielded electric wire is reduced, and earthing performance of a connector, a device, and the like is reduced with the shielding wire.

Accordingly, an assignee of the present application has disclosed a structure and a method for connecting a braid of a shielded electric wire as shown in FIGS. 10A to 10C (JP, 2000-58153, A, pages 3 to 4, FIG. 2).

As shown in FIG. 10B, a low-melting-point material 21 such as solder is coated on an inner wall of a pressure-jointed part 2 of a shielding (earthing) terminal 1. Then, the pressure-jointed part 2 of the terminal 1 is disposed on a braid 13 of a shielded electric wire 15. Then, an upper mold 22 for pressure-jointing vibrates as an ultrasonic phone and presses the pressure-jointed part with a lower mold (an anvil) 23 to melt the low-melting-point material 21 and weld the braid 13 to the pressure-jointed part 2 of the terminal 1 with the low-melting-point material 21.

As shown in FIG. 10A, another main terminal 16 is pressure-jointed onto a conductive core wire 11 of the shielding wire 15. Since the core wire 11 is a metallic material having low contractility, the main terminal 16 is pressure-jointed so firmly as not to loosen with time. A main electric current or a main signal is passed through the main terminal 16. An inner insulating layer 12 is formed on an outer periphery of the core wire 11, the braid 13 is formed on an outer periphery of the inner insulating layer 12, and an outer insulator 14 is formed on an outer periphery of the braid 13.

As shown in FIG. 10B, the shielding terminal 1 has a substantially L-shaped tabular part 8 disposed parallel to the main terminal 16. As shown in FIG. 10C, after the shielding terminal 1 is pressure-jointed onto the braid 13, both the shielding terminal 1 and the main terminal 16 are received in a connector housing of a connector (not shown) in order to be connected to a mating connector of a device or a wiring harness. The shielding terminal 1 is grounded, for example, to allow an electric noise from the device or the mating connector to flow through the braid 13 to the earth.

However, since the conventional structure and method for connecting the braid of the shielding wire as described above requires an apparatus for vibrating the upper mold 22 as an ultrasonic phone, there is a problem that a pressure-jointing machine becomes complex, large, and expensive. Further, there is a worry that a durability of the inner insulating layer 12 made of synthetic resin is reduced under an influence of heat accompanying melting of the low-melting-point material 21.

Accordingly, an object of this invention is to provide a structure and a method for connecting a braid of a shielding wire that allow the braid to be electrically connected to a terminal easily and reliably at low cost without reduction of conductivity with time, using a large-scale apparatus, and an influence of heat.

### SUMMARY OF THE INVENTION

In order to attain the object, according to the present invention, there is provided a structure for connecting a braid of a shielding wire, including:

a braid formed on an outer wall of an inner insulating layer of the shielding wire;

a terminal pressure-jointed onto the braid;

a conductive adhering member interposed between the braid and the terminal, with which the braid and the terminal being jointed and electrically connected to each other.

According to the above, a pressure-jointing force of the terminal presses the braid against the inner insulating layer. Therefore, if a diameter of the inner insulating layer is reduced with time, and contact pressure between the braid and the terminal is reduced, since the braid and the terminal are jointed with the conductive adhering member, electric resistivity between the braid and the terminal is not increased, and a good conductivity between the braid and the terminal is maintained for a long time.

Preferably, the conductive adhering member includes a conductive tape and a conductive adhesive coated on both front and rear surfaces of the conductive tape.

According to the above, the terminal and the braid are electrically connected to each other by the conductive adhesive on an outer surface of the conductive tape adhering onto an inner wall of the terminal to be electrically connected thereto, and the conductive adhesive on an inner surface of the conductive tape adhering onto an outer wall of the braid to be electrically connected thereto. The conductive adhesive is at least coated on both front and rear surfaces, or a periphery (front, rear and side surfaces) of the conductive tape.

Preferably, the conductive adhering member includes a nonconductive tape and a conductive adhesive coated on a periphery of the nonconductive tape.

According to the above, the conductive adhesive coated on an outer surface of the nonconductive tape adheres to an inner wall of the terminal, and the conductive adhesive coated on an inner surface of the nonconductive tape adheres to an outer wall of the braid. Thereby, the terminal and the braid are electrically connected to each other through the conductive adhesive coated at a side surface or both side surfaces of the nonconductive tape. Namely, the terminal and the braid are electrically connected to each other through the conductive adhesive coated on the periphery of the nonconductive tape.

Preferably, the conductive adhering member includes a nonconductive tape and a conductive adhesive penetrating into the nonconductive tape.

According to the above, the conductive adhesive coated on an outer surface of the nonconductive tape adheres to an inner wall of the terminal, and the conductive adhesive coated on an inner surface of the nonconductive tape adheres to an outer wall of the braid. Thereby, the terminal and the braid are electrically connected to each other through the conductive adhesive impregnated nonconductive tape body. Namely, the terminal and the braid are electrically connected to each other through the conductive adhesive penetrating into the nonconductive tape. Preferably, for example, porous material such as nonwoven cloth is used as the nonconductive tape. Preferably, the conductive adhesive has low viscosity, high permeability and the viscosity increases after the conductive adhesive penetrates into the nonconductive tape.

According to another aspect of the present invention, there is provided a method for connecting a braid of a shielding wire, including the steps of:

providing a conductive adhering member on either an inner wall of the terminal or an outer wall of the braid;

arranging the conductive adhering member so as to be interposed between the terminal and the braid; and

pressure-jointing the terminal onto the braid in order to electrically connect the terminal to the braid.

According to the above, a pressure-jointing force of the terminal presses the braid against the inner insulating layer. Therefore, if a diameter of the inner insulating layer is reduced with time, and contact pressure between the braid and the terminal is reduced, since the braid and the terminal are jointed with the conductive adhering member, electric resistivity between the braid and the terminal is not increased, and a good conductivity between the braid and the terminal is maintained for a long time. The conductive adhering member may have a conductive tape and a conductive adhesive coated on both front and rear surfaces of the conductive tape. Alternatively, the conductive adhering member may have a nonconductive tape and a conductive adhesive coated on a periphery of the conductive tape. Alternatively, the conductive adhering member may have a nonconductive tape and a conductive adhesive penetrating into the nonconductive tape.

The above and other objects, features, and advantages of the present invention will be better understood when taken in connection with the accompanying drawings and description.

### BRIEF DESCRIPTION OF THE DRAWINGS

FIG. 1 is a perspective view showing a terminal used in a first embodiment of a structure and a method for connecting a braid of a shielding wire according to the present invention;

FIG. 2 is a perspective view showing a conductive tape to adhere to the terminal used in the first embodiment according to the present invention;

FIG. 3 is a perspective view showing an embodiment of a method for making the conductive tape adhere onto the terminal according to the present invention;

FIG. 4 is a perspective view showing the shielding wire having the braid onto which the terminal is pressure-jointed and electrically connected according to the present invention;

FIG. 5 is a sectional view taken on line A-A′ of FIG. 4;

FIG. 6A is a partially enlarged view of a part surrounded by a circle in FIG. 5;

FIG. 6 is a sectional view showing a conductive adhering member having the conductive tape;

FIG. 7 is a sectional view showing one example of the conductive adhering member having a nonconductive tape;

FIGS. 8A and 8B are sectional views showing another example of the conductive adhering member having the nonconductive tape;

FIG. 9 is a perspective view showing a second embodiment of the structure and the method for connecting a braid of a shielding wire according to the present invention; and

FIGS. 10A, 10B and 10C are perspective views showing a conventional method for connecting a braid of a shielding wire in turn.

### DESCRIPTION OF THE PREFERRED EMBODIMENTS

A first embodiment of a structure and a method for connecting a braid of a shielding wire according to the present invention will be described below with reference to FIGS. 1 to 5.

As shown in FIG. 1, a conductive tape 3 is stuck on an inner wall of a pressure-jointed part 2 of a conductive metallic terminal 1 for shielding (earthing). A conductive adhesive 4 is coated on both front and rear surfaces of the conductive tape 3. The conductive tape 3 is stuck on the inner wall of the terminal 1 with the conductive adhesive 4 on the back side of the conductive tape 3.

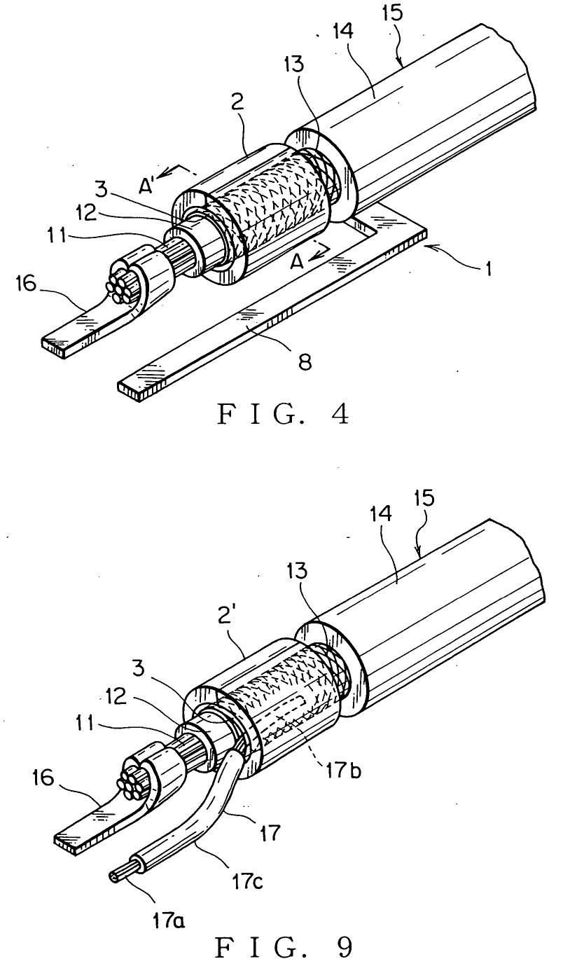

As shown in FIG. 4, when the terminal 1 is pressure-jointed onto the shielding wire 15, a conductive braid 13 of a shielding wire 15 is jointed to the front side of the conductive tape 3 with the conductive adhesive 4 coated on the front side of the conductive tape 3, and is electrically connected to the conductive tape 3.

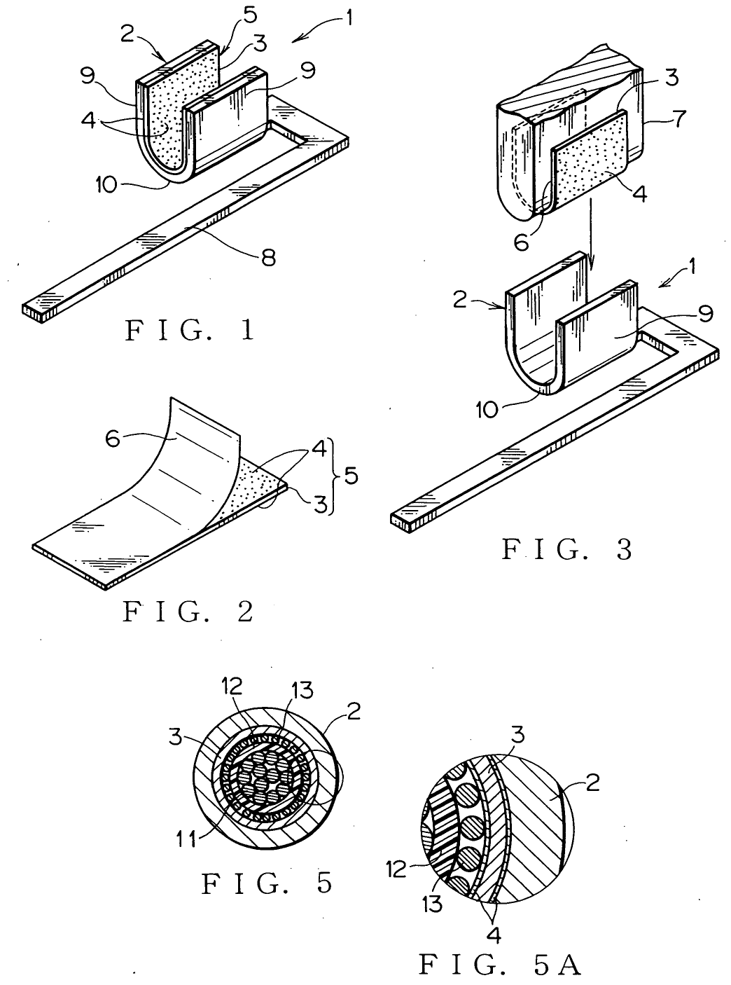

As shown in FIG. 2, a front side of a virgin conductive tape 3 is covered with a releasable insulating tape (releasing paper) 6, and rolled spirally (not shown) like a normal two-sided tape so that a back side of the conductive tape 3 is covered with a lower (inner) part of the insulating tape (not shown). When the conductive tape 3 is formed in a flat sheet shape, both front and rear surfaces of the conductive tape 3 are respectively covered with the releasable insulating tapes 6.

Preferably, conductive metal such as a copper foil, or an aluminum foil is used as the conductive tape 3. Alternatively, a metal braid like the shielding braid of the shielding wire can be used.

Preferably, a mixture of an adhesive such as an epoxy resin adhesive, a hot melt adhesive, a rubber based solvent adhesive, an elastic adhesive, and a phenol resin adhesive, and a fiber or a powder of such as conductive metallic material or carbon is used as the conductive adhesive 4 coated onto both front and rear surfaces of the conductive tape 3.

Alternatively, a metal foil or the like is not used as the conductive tape 3, and the mixture of an adhesive and a fiber or a powder of conductive metallic material or carbon is directly used as the conductive tape 3. In this case also, the conductive tape 3 is covered with the releasable tape 6 to be prevented from an unintentional adherence. Alternatively, a porous nonconductive tape such as a nonwoven impregnated with the conductive adhesive 4 can be used as the conductive tape 3. In these cases, the tape itself is called as a conductive adhering member.

When used, the conductive tape 3 is cut to an appropriate length and an appropriate shape, and the releasable tape 6 is released from the conductive tape 3. Then, as shown in FIG. 1, the conductive tape 3 is stuck on an inner wall of the pressure-jointed part 2 of the shielding terminal 1.

As an example shown in FIG. 3, a sucking tool 7 sucks the conductive tape 3 adhering the releasable tape 6 on the front side thereof through the releasable tape 6, and pushes the bask side of the conductive tape 3, on which the conductive adhesive 4 is exposed, against the pressure-jointed part 2 of the terminal 1 to stick the conductive tape 3 on the pressure-jointed part 2. Then, a hand or the sucking tool 7 releases the releasable tape 6 from the front side of the conductive tape 3. Then, as shown in FIG. 4, the pressure-jointed part 2 of the terminal 1 is pressure-jointed onto the braid 13 of the shielding wire 15.

The sucking tool 7 is formed in a substantially U shape following a shape of the pressure-jointed part 2, and has a plurality of holes (at least one at each of left and right sides) for sucking the conductive tape 3 (not shown). The holes are connected to a vacuum pump (not shown).

The sucking operation described above is adapted to an automatic pressure-jointing machine (not shown). In a case of high-mix low-volume production, the conductive tape 3 can be stuck on the pressure-jointed part 2 by hand.

When using the automatic pressure-jointing machine (not shown), a punch and a die, a cutter blade (not shown), or the like can be used for cutting the conductive tape 3. When cutting by hand, scissors, a tape cutter for a rolled tape, or the like can be used for cutting the conductive tape 3.

As shown in FIG. 1, the terminal 1 has a substantially L or U-shaped tabular part 8 at a base of the substantially U-shaped rolled pressure-jointed part 2. The pressure-jointed part 2 has a pair of left and right pressure-jointing pieces 9 and a curved bottom part 10 continued to the pressure-jointing pieces 9. The bottom part 10 is continued to the tabular part 8 as a base plate.

The terminal shown in FIG. 1 is merely an example. Alternatively, a terminal (not shown) having a base plate continued to the pressure-jointed part and an outer contact part formed in a cylinder or a rectangular tube shape can be used as another example. This shape of the terminal is disclosed in JP, 2003-151694, Y by the assignee of the present application. According to this document, a core wire of the shielding wire (a coaxial cable) is connected to another main terminal. The another main terminal is received in a connector housing made of insulating synthetic resin at an inside of an outer contact part. The outer contact part covers an outer peripheral wall of the connector housing.

Alternatively, another terminal (not shown) having a flange-shaped electric contact continued to a pressure-jointed part can be used, in which the flange-shaped electric contact contacts an earthing terminal of a connector housing.

Further, the pressure-jointed part 2 is not limited to the one having a pair of pressure-jointing pieces 9. A cylinder-shaped pressure-jointed part 2 can be used, wherein the pressure-jointed part 2 is pressure-jointed onto the braid 13 of the shielding wire 15 by pressure-jointing all around the outer periphery of the pressure-jointing part 2 such as swaging.

The conductive tape 3 is stuck on an inner wall of the pressure-jointed part 2 of the terminal 1 of FIG. 1. Then, The braid 13 of the shielding wire 15 is disposed in the interior of the pressure-jointed part 2. Then, as shown in FIG. 4, the pressure-jointed part 2 is pressure-jointed and deformed into a cylinder shape as shown in FIG. 4 by the upper and lower molds of a pressure-jointing machine similar to an existing pressure-jointing machine without a conventional ultrasonic vibrating mechanism.

According to the above, as shown in FIGS. 5 and 5A, the conductive tape 3 contacts tightly both the pressure-jointed part 2 and the braid 13 without any gap, and is formed in a circular shape. The outer side of the conductive tape 3 is stuck on the inner peripheral wall of the pressure-jointed part 2 with the conductive adhesive 4. The inner side of the conductive tape 3 is stuck on the outer periphery of the braid 13 with the conductive adhesive 4. The pressure-jointed part 2 and the braid 13 are fixed firmly through the conductive tape 3 and the conductive adhesive 4 coated on both front and rear surfaces of the conductive tape 3, and electrically connected to each other.

The inner insulating layer 12 made of synthetic resin is disposed in the interior of the braid 13. The core wire 11 is disposed in the interior of the inner insulating layer 12. As shown in FIG. 4, the main terminal 16 is pressure-jointed onto the core wire 11 previously, or after the shielding terminal 1 is pressure-jointed. The outer periphery of the braid 13 is covered with an outer insulating layer 14 made of synthetic resin. An outer diameter of the outer insulating layer 14 is nearly equal to that of the cylinder-shaped pressure-jointed part 2 of the terminal 1, and disposed coaxially with the pressure-jointed part 2 in series with each other

After the pressure-jointed part 2 is pressure-jointed onto the braid 13, since the braid 13 and the pressure-jointed part 2 are jointed firmly with the conductive tape 3 on which the conductive adhesive 4 is coated, even if a diameter of the inner insulating layer 12 is reduced with time, contact pressure between the braid 13 and the pressure-jointed part 2 is reduced, and a gap is generated between the braid 13 and the inner insulating layer 12, electric resistivity between the braid 13 and the pressure-jointed part 2 is not increased, and a good conductivity between the braid 13 and the pressure-jointed part 2 is maintained for a long time. Resultingly, a good shielding performance of the shielding wire 15 is maintained for a long time.

In the above embodiment, the conductive tape 3 having the conductive adhesive 4 is used as the conductive adhering member, however, alternatively, other conductive adhering members (not shown) such as an adhesive conductive paste or a conductive adhesive can be used.

The conductive paste or the conductive adhesive is coated on an inner wall of the pressure-jointed part 2 shown in FIG. 1 or an outer periphery of the braid 13 shown in FIG. 4, and then in this condition, the pressure-jointed part 2 is pressure-jointed onto the braid 13. Preferably, the conductive paste and the conductive adhesive are soft when coating or adhering but will be hard with time.

Alternatively, conductive foil such as a copper foil (not shown) can be used as the braid 13 of the shielding wire 15. The conductive foil and the pressure-jointed part 2 of the terminal 1 can be connected with the conductive adhering member such as the conductive tape 3 having a conductive adhesive or a conductive adhesive.

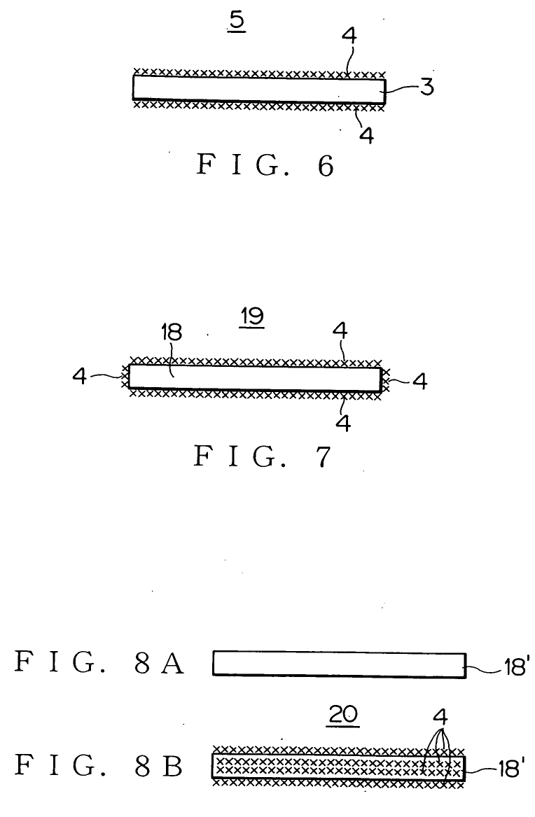

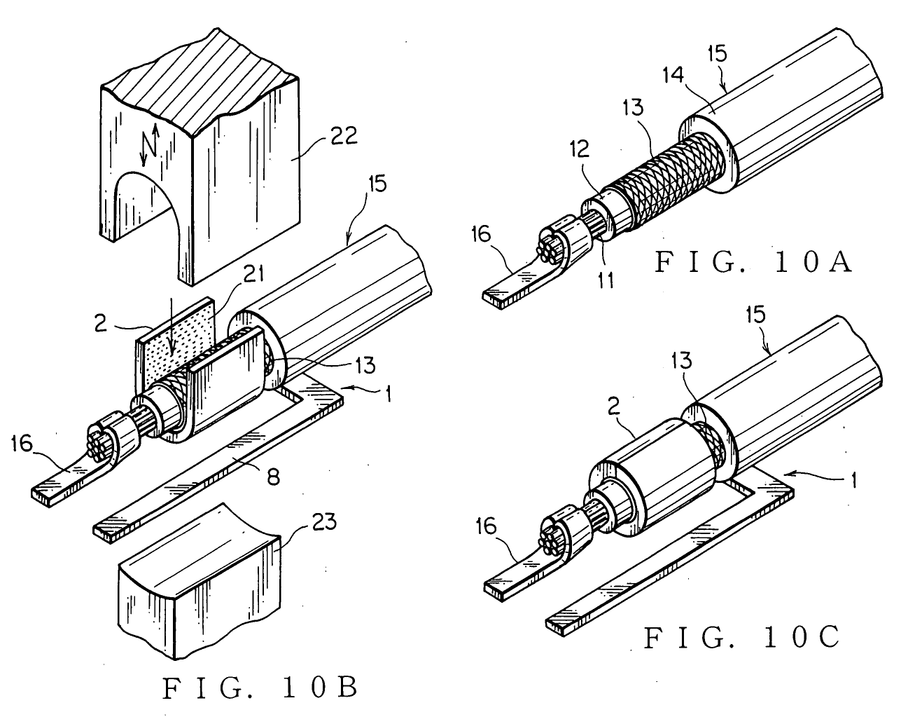

As shown in FIG. 6, a conductive adhering member 5 having the conductive tape 3 and the conductive adhesive 4 is formed by coating front and rear surfaces of the conductive tape 3 with the conductive adhesive 4. Side surfaces of the conductive tape 3 do not needed to be coated with the conductive adhesive 4.

As shown in FIG. 7, when using a nonconductive tape 18 instead of the conductive tape 3, a conductive adhering member 19 is formed by coating the nonconductive tape 18 with the conductive adhesive 4 at front, rear and side surfaces in a width direction thereof. Preferably, both side surfaces in the width direction of the nonconductive tape 18 are coated with the conductive adhesive 4. The conductive adhesive 4 coated on the front and rear surfaces are electrically connected to each other through the conductive adhesive 4 coated at the side surfaces.

As shown in FIGS. 8A and 8B, when a conductive adhering member 20 is formed by using the porous tape such as nonwoven cloth as a nonconductive tape 18′, the nonconductive tape 18′ is coated with the conductive adhesive 4 after or before the long nonconductive tape 18′ is cut to specific length pieces. Alternatively, the nonconductive tape 18′ is immersed in a container with the conductive adhesive 4. Thereby, the conductive adhesive 4 penetrates into an inside of the nonconductive tape 18′ and the front and rear surface of the nonconductive tape 18′ is electrically connected to each other through the conductive adhesive 4 inside thereof.

FIG. 9 shows a second embodiment of a structure and a method for connecting a braid of a shielding wire. In the second embodiment, the conductive adhering member 5 having the conductive tape 3 and the conductive adhesive 4 coated to the front and rear surfaces of the conductive tape 3 is used. However, the conductive adhering members 19, 20 may be used.

A terminal 2′ is used instead of the terminal 1 shown in FIG. 1. An electric wire 17 is used instead of the tabular part 8 of the terminal 1. The wire 17 is caught in between the shielding wire 15 and the braid 13.

A shape of the terminal 2′ is substantially the same as that of the pressure-jointed part 2 of the terminal 1. Namely, the terminal 2′ has a substantially U-shape initially, and a circular (cylinder) shape after being pressure-jointed. Like the first embodiment, the conductive tape 3, on both front and rear surfaces of which the conductive adhesive 4 is coated, is stuck on an inner wall of the terminal 2′. An exposed conductive core wire 17b of the wire 17 is caught in between the conductive tape 3 and the braid 13, and electrically connected to both the terminal 2′ and the braid 13.

After pressure-jointing, the conductive core wire 17b of the wire 17 is so pressed on the braid 13 as to bite into the braid 13. In addition, the conductive core wire 17b is firmly jointed to the inner side of the conductive tape 3 and the braid 13 of the terminal 2′ with the conductive adhesive 4. Therefore, the wire 17 is reliably prevented from slipping out of the terminal 2′ owing to the passage of time. Further, a connection between the braid 13 and the wire 17 does not loosen with time, and a good conductivity between the braid 13 and the wire 17 is maintained for a long time.

The conductive core wire 17a of the wire 17 is connected to the earth of a device (not shown) by screwing or soldering. Alternatively, a small terminal (not shown) is pressure-jointed onto the core wire 17a, and received in a connector housing together with the main terminal 16 to be connected to a mating connector (not shown) of the device or a wiring harness. The core wire 17 is used as a shielding earth. An insulating layer 17c of the wire 17 is stripped at both ends of the wire 17 to form conductive core wires 17a, 17b.

In the second embodiment as shown in FIG. 9, the conductive paste and the conductive adhesive can be used instead of the conductive tape 3 and the conductive adhesive 4. Further, another method described below can be used. First, the core wire 17b is caught between the terminal 2′ and the conductive tape 3 as a preliminary fixing. Then, in this state, the braid 13 of the shielding wire 15 is disposed in the interior of the terminal 2′, and pressure-jointed as a final fixing as shown in FIG. 9. The shapes of the terminal 2′, the main terminal 16, and the like can be changed properly. Swaging can be used as a pressure-jointing process.

According to the present invention, both pressure-jointing and adherence between the braid 13 and the terminal 1, 2′ are made easily at low cost by an existing pressure-jointing machine. Therefore, a shielding wire 15 having a terminal 1, 2′ is produced at low cost in high productivity. Further, since the braid 13 adheres on the terminal 1, 2′ without an influence of heat, a durability of the inner insulating layer 12 is improved.

According to the present invention, by using the conductive tape 3 or nonconductive tapes 18, 18′, the weight of the shielding wire 15 with the terminal 1, 2′ can be reduced, and the diameter of the shielding wire 15 can be reduced. Further, the tape 3, 18, 18′ are handled easily in a manner that the conductive tapes 3 18, 18′ are cut, and the releasable tape 6 is removed like a normal two-sided tape. Therefore, workability of sticking the conductive tapes 3 18, 18′ on the terminal 1, 2′ or the braid 13 is improved.

Having now fully described the present invention, it will be apparent to one of ordinary skill in the art that many changes and modifications can be made thereto without departing from the scope of the invention as set forth herein.

What is claimed is:

1. A structure for connecting a braid of a shielding wire, comprising:
a braid formed on an outer wall of an inner insulating layer of the shielding wire;
a terminal pressure-jointed onto the braid;
a conductive adhering member interposed between the braid and the terminal, with which the braid and the terminal being jointed and electrically connected to each other.

2. The structure for connecting a braid of a shielding wire as claimed in claim 1,
wherein the conductive adhering member includes a conductive tape and a conductive adhesive coated on both front and rear surfaces of the conductive tape.

3. The structure for connecting a braid of a shielding wire as claimed in claim 1,
wherein the conductive adhering member includes a nonconductive tape and a conductive adhesive coated on a periphery of the nonconductive tape.

4. The structure for connecting a braid of a shielding wire as claimed in claim 1,
wherein the conductive adhering member includes a nonconductive tape and a conductive adhesive penetrating into the nonconductive tape.

5. A method for connecting a braid of a shielding wire, comprising the steps of:
providing a conductive adhering member on either an inner wall of the terminal or an outer wall of the braid;
arranging the conductive adhering member so as to be interposed between the terminal and the braid; and
pressure-jointing the terminal onto the braid in order to electrically connect the terminal to the braid.
